(19) United States
(12) Patent Application Publication
(10) Pub. No.: US 2025/0260314 A1
(43) Pub. Date: Aug. 14, 2025

(54) ELECTRONIC DEVICE INCLUDING A POWER FACTOR CORRECTION CIRCUIT AND METHOD FOR CONTROLLING THE POWER FACTOR CORRECTION CIRCUIT

(71) Applicant: SAMSUNG ELECTRONICS CO., LTD., Suwon-si (KR)

(72) Inventors: Keonwoo Kim, Suwon-si (KR); Moonyoung Kim, Suwon-si (KR)

(73) Assignee: SAMSUNG ELECTRONICS CO., LTD., Suwon-si (KR)

(21) Appl. No.: 19/192,982

(22) Filed: Apr. 29, 2025

Related U.S. Application Data
(63) Continuation of application No. PCT/KR2025/001855, filed on Feb. 7, 2025.

(30) Foreign Application Priority Data
Feb. 8, 2024 (KR) 10-2024-0019432

(51) Int. Cl. H02M 1/42; H02M 7/06

(52) U.S. Cl. CPC H02M 1/4291; H02M 7/06

(57) ABSTRACT

An electronic device is provided. The electronic device includes: a power factor correction (PFC) circuit; a rectifier circuit configured to rectify an alternating current voltage to obtain an input voltage having a negative polarity and provide the input voltage to the PFC circuit; and a protecting circuit configured to protect the PFC circuit. The PFC circuit includes: a first diode; an inductor configured to store energy based on the input voltage provided by the rectifier circuit while a switching circuit is turned on and provide energy while the switching circuit is turned off; and an output capacitor connected to the inductor through the first diode, and configured to provide an output voltage having a positive polarity by using the energy provided by the inductor while the switching circuit is turned off.

### CROSS-REFERENCE TO RELATED APPLICATIONS

This application is a bypass continuation application of International Application No. PCT/KR2025/001855, filed on Feb. 7, 2025, which claims priority to Korean Patent Application No. 10-2024-0019432, filed on Feb. 8, 2024, in the Korean Intellectual Property Office, the disclosures of which are incorporated by reference herein in their entireties.

### BACKGROUND

### 1. Field of the Invention

The present disclosure relates to an electronic device including a power factor correction (PFC) circuit and a method for controlling the PFC circuit.

### 2. Description of the Related Art

Various types of electronic devices have been developed, including low-profile electronic devices such as an ultra-slim TV.

Electronic devices may include a power circuit which supplies power to components of the electronic devices. The power circuit may include a PFC to satisfy power factor and harmonic wave regulations.

Accordingly, there is a need for a PFC circuit suitable for low-profile electronic devices.

### SUMMARY OF THE INVENTION

In accordance with an aspect of the disclosure, an electronic device includes: a power factor correction (PFC) circuit; a rectifier circuit configured to rectify an alternating current voltage to obtain an input voltage having a negative polarity and provide the input voltage to the PFC circuit; and a protecting circuit configured to protect the PFC circuit. The PFC circuit includes: a first diode; an inductor configured to store energy based on the input voltage provided by the rectifier circuit while a switching circuit is turned on and provide energy while the switching circuit is turned off; and an output capacitor connected to the inductor through the first diode, and configured to provide an output voltage having a positive polarity by using the energy provided by the inductor while the switching circuit is turned off. Based on the first diode being short-circuited, the PFC circuit is protected by a current path formed by the protecting circuit while the switching circuit is turned on.

The protecting circuit may include a second diode which is connected to the output capacitor in parallel.

The rectifier circuit may include a diode bridge, and the PFC circuit may further include an input capacitor configured to receive the input voltage from the diode bridge.

A first end of the switching circuit may be connected to one end of the input capacitor, one end of the inductor may be connected to another end of the input capacitor and an anode of the first diode, another end of the inductor may be connected to one end of a resistor, one end of the output capacitor may be connected to a cathode of the first diode and a cathode of the second diode, another end of the output capacitor may be connected to the other end of the resistor, a second end of the switching circuit, a ground voltage, and an anode of the second diode, and the resistor may be used to sense current flowing through the inductor.

The PFC circuit may be driven in a critical conduction mode (CrM) based on the current flowing through the inductor, and the current may be sensed using the resistor.

A first end of the switching circuit may be connected to one end of the input capacitor, one end of the inductor may be connected to another end of the input capacitor, an anode of the first diode, and one end of a first resistor, another end of the first resistor may be connected to one end of a second resistor, one end of the output capacitor may be connected to a cathode of the first diode and a cathode of the second diode, another end of the output capacitor may be connected to another end of the inductor, another end of the second resistor, a second end of the switching circuit, a ground voltage, and an anode of the second diode, and the first resistor and the second resistor may be used to sense current flowing through the inductor.

The PFC circuit may be driven in a CrM based on the current of the inductor sensed using the first resistor and the second resistor.

Based on the switching circuit being turned on in a state where the first diode is short-circuited due to a failure, a voltage charged in the output capacitor by the input voltage may be discharged, and based on the voltage of both ends of the output capacitor becoming zero according to the discharge, the current path may flow through the second diode.

The electronic device may further include a fuse. The fuse may be disconnected by current flowing through the current path to terminate an operation of the PFC circuit.

The electronic device may further include a fuse. Based on the switching circuit being short-circuited due to a failure, the fuse may be disconnected by current flowing through the switching circuit to terminate and an operation of the PFC circuit.

The electronic device may further include: an electromagnetic interference (EMI) filter configured to filter a source alternating current voltage and provide the alternating current voltage to the rectifier circuit; and a DC/DC converter to which the output voltage is applied.

In accordance with an aspect of the disclosure, a method for controlling a PFC circuit of an electronic device, including a PFC circuit, a rectifier circuit configured to apply an input voltage having a negative polarity to the PFC circuit by rectifying an alternating current voltage, and a protecting circuit configured to protect the PFC circuit, is provided. The method includes: controlling a switching circuit from an on state to an off state by applying a gate signal to a gate terminal of the switching circuit of the PFC circuit; sensing current flowing through an inductor of the PFC circuit while the switching circuit is in the off state; controlling the switching circuit from the off state to the on state by applying the gate signal to the gate terminal of the switching circuit of the PFC circuit based on the sensed current; storing energy in the inductor based on the input voltage applied from the rectifier circuit while the switching circuit is in the on state; and providing, while the switching circuit is in the off state, an output voltage having a positive polarity using an output capacitor of the PFC circuit that is connected to the inductor through a first diode. Based on the first diode being short-circuited, the PFC circuit is protected by a current path formed by the protecting circuit while the switching circuit is turned on.

The protecting circuit may include a second diode which is connected to the output capacitor in parallel.

The rectifier circuit may include a diode bridge, and the method may further include receiving the input voltage from the rectifier circuit at an input capacitor of the PFC circuit.

One end of the switching circuit may be connected to one end of the input capacitor, one end of the inductor may be connected to another end of the input capacitor and an anode of the first diode, another end of the inductor may be connected to one end of a resistor, one end of the output capacitor may be connected to a cathode of the first diode and a cathode of the second diode, another end of the output capacitor may be connected to another end of the resistor, a second end of the switching circuit, a ground voltage, and an anode of the second diode, and the method may further include sensing current flowing through the inductor using the resistor.

In accordance with an aspect of the disclosure, an electronic device includes: a PFC circuit; a protecting circuit including: a first diode; an inductor configured to store energy based on an input voltage while a switching circuit is turned on and provide energy while the switching circuit is turned off; and an output capacitor connected to the inductor through the first diode, and configured to provide an output voltage having a positive polarity by using the energy provided by the inductor while the switching circuit is turned off; and a PFC controller configured to control the switching circuit to turn on and off based on current flowing through the inductor.

The PFC controller may be further configured to control the switching circuit to turn on based on the current flowing through the inductor being zero.

The PFC controller may be further configured to control the switching circuit to turn off based on a threshold time passing after controlling the switching circuit to turn on.

### BRIEF DESCRIPTION OF THE DRAWINGS

The above and other aspects, features, and advantages of certain embodiments of the present disclosure will be more apparent from the following description taken in conjunction with the accompanying drawings, in which:

FIGS. 1A, 1B and 1C are views illustrating an example of a power factor correction (PFC) circuit;

FIG. 2 is a block diagram illustrating a configuration of an electronic device according to an embodiment;

FIG. 3 is a view illustrating a rectifier circuit, a PFC circuit, and a protecting circuit according to an embodiment;

FIGS. 4A and 4B are views illustrating operations of a rectifier circuit, a PFC circuit, and a protecting circuit according to an embodiment;

FIGS. 5A, 5B, and 5C are views illustrating operations for protecting the PFC circuit according to an embodiment;

FIG. 6 is a view illustrating a rectifier circuit, a PFC circuit, and a protecting circuit according to an embodiment;

FIGS. 7 and 8 are views illustrating an example of power circuits according to embodiments;

FIG. 9 is a block diagram illustrating a configuration of an electronic device according to an embodiment;

FIG. 10 is a view illustrating a method of providing power to a PFC controller according to an embodiment;

FIG. 11 is a block diagram illustrating a configuration of an electronic device according to an embodiment;

FIG. 12 is a view illustrating a method of providing power to a second gate driver according to an embodiment;

FIGS. 13A, 13B, 14A, and 14B are views illustrating a rectifier circuit, a PFC circuit, and a protecting circuit according to an embodiment; and

FIG. 15 is a flow chart illustrating a method of controlling a PFC circuit of an electronic device according to an embodiment.

### DETAILED DESCRIPTION

Embodiments are described below with reference to the accompanying drawings. Embodiments described herein are examples, and thus, the present disclosure is not limited thereto, and may be realized in various other forms. Each embodiment provided in the following description is not excluded from being associated with one or more features of another example or another embodiment also provided herein or not provided herein but consistent with the present disclosure. Expressions such as “at least one of a, b, or c” may designate “a”, “b”, “c”, “a and b”, “a and c”, “b and c”, “all of a, b, and c”, or variants thereof.

The terms used herein are selected to be general terms which are currently and widely used as much as possible in consideration of functions in the disclosure. However, the terms may be varied according to intention of those skilled in the art or precedents, emergence of new technologies, etc. Also, there may be a term arbitrarily selected by the applicant in a specific case. In this case, the meaning of the term is specifically described in the corresponding part of the description. Therefore, the term used in the disclosure should be defined based on the meaning of the term and the contents throughout an entire specification other than the simple name of the term.

The singular expression may include the plural expression unless otherwise explicitly noted in the context. The terms used herein including technical or scientific terms may have the same meaning as that generally understood by those skilled in the art described in the specification. As used herein, the terms “1st” or “first” and “2nd” or “second” may use corresponding components regardless of importance or order and are used to distinguish a component from another component without limiting the components.

Throughout the specification, unless explicitly described to the contrary, the expression that a part “comprises” a component will be understood to imply the inclusion of the stated component but not the exclusion of the component. In addition, terms such as “part”, “module”, etc., which are described in the specification, indicate a unit that processes at least one function or operation. The unit may be realized by hardware.

The term “and/or” include combinations of a plurality of related described components or any component of the plurality of related described components.

Various elements and areas of the drawings are schematically depicted. Therefore, embodiments are not limited by the relative size or spacing depicted in the attached drawings.

Hereinafter, the disclosure is described with reference to the attached drawings.

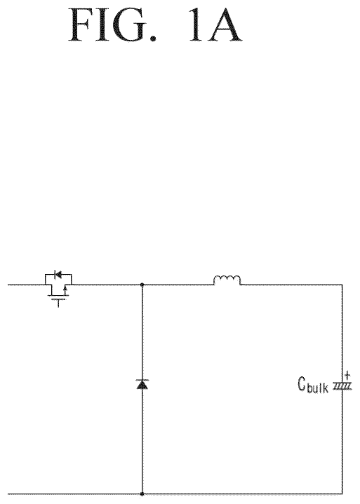

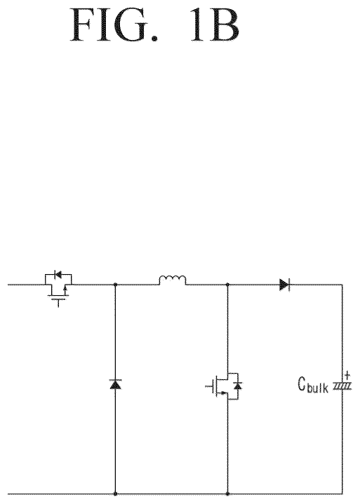

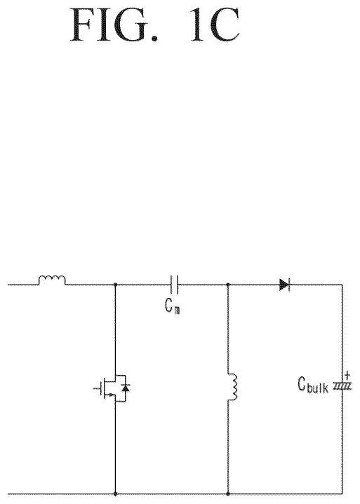

FIGS. 1A to 1C are views illustrating an example of a power factor correction (PFC) circuit.

A power circuit having 75 W or more of output power is to use a PFC circuit to satisfy power factor-related and high frequency-related regulations (e.g., regulatory conditions related to total harmonic distortion (THD)). For example, the PFC circuit may include a boost converter-based PFC circuit

However, it is difficult to use the boost converter-based PFC circuit in the electric device (e.g., an ultra-slim TV, etc.) in which a power circuit is required in an ultra-slim form (or a slim form).

Specifically, the boost converter is a step-up converter, wherein an input voltage is higher than an output voltage. Therefore, an output capacitor of the boost converter is to be an electrolytic capacitor having a high internal pressure. However, a capacitor having a high internal pressure has a great diameter, which is not suitable for an ultra-slim power circuit. Also, when an additional winding is used for zero current detection (ZCD), a large inductor is used.

To overcome this problem, a step-down converter in which an output capacitor having a low internal pressure may be used for a PFC circuit. The step-down converter may be a buck converter, a two switching buck-boost converter, a single-ended primary-inductor converter (SEPIC converter), etc.

FIG. 1A is a view illustrating an example of a buck converter. The buck converter has advantages of a simple structure and a small number of elements. However, based on a switching circuit element (e.g., a switch circuit, such as a metal oxide semiconductor field effect transistor (MOSFET)) being short-circuited due to a failure, there is a problem that the input voltage may be applied to the output capacitor (e.g., C_{bulk}), which may cause the output capacitor to explode.

FIG. 1B is a view illustrating an example of the two switching buck-boost converter. The two switching buck-boost converter is a converter in which both step-up and step-down are possible. Accordingly, there is an advantage of being capable of controlling an output voltage regardless of a magnitude of the input voltage. However, similar to the buck converter, there is a problem that based on the switching circuit element being short-circuited due to a failure, the output capacitor (e.g., C_{bulk}) may explode.

FIG. 1C is a view illustrating an example of the SEPIC converter. An input and output of the SEPIC converter are separated due to the capacitor (Cm). In this regard, even though the switching circuit element is short-circuited, the output capacitor (e.g., C_{bulk}) may be protected. However, the SEPIC converter has a topology of requiring two inductors and thus has a disadvantage that increased size and cost of the converter is required.

Also, each of the aforementioned step-down converters require additional winding for ZCD. Thus, similar to the boost converter, there is problem that a magnitude of the inductor is great.

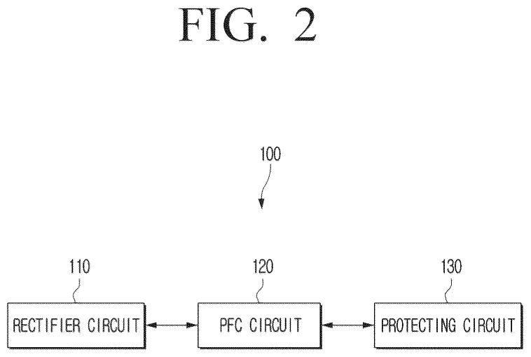

FIG. 2 is a block diagram illustrating a configuration of an electronic device according to an embodiment.

The electronic device 100 may include a power circuit for receiving external power (e.g., commercial power) and providing power to each component of the electronic device 100. The power circuit may include a buck boost converter based-power factor correction (PFC) circuit.

For example, with reference to FIG. 2, the electronic device 100 includes a rectifier circuit 110, a PFC circuit 120, and a protecting circuit 130.

The rectifier circuit 110 receives an external voltage. The external voltage may be an AC voltage applied from the external power. The rectifier circuit 110 may rectify the input AC voltage.

The PFC circuit 120 may improve a power factor. For this, the PFC circuit 120 may include the buck boost converter. The buck boost converter may operate as a step-up converter or operate as a step-down converter according to a duty ratio of the switching circuit element.

In the disclosure, the duty ratio of the switching circuit element may be set such that the buck boost converter operates as the step-down converter. The PFC circuit 120 may operate as the step down converter and generate an output voltage lower than an input voltage according to a switching operation of the switching circuit element.

Due to a circuit structure of the PFC circuit 120, a polarity of the output voltage of the PFC circuit 120 may be opposite to a polarity of the input voltage thereof. According to the disclosure, in consideration of this, an input voltage having a negative polarity may be applied to the PFC circuit 120 by using the rectifier circuit 110. For example, the rectifier circuit 110 may rectify an AC voltage and apply an input voltage having a negative polarity to the PFC circuit 120.

The PFC circuit 120 may include a switching circuit element, an inductor, a first diode, and an output capacitor.

The switching circuit element may be, for example, a MOSFET. The inductor may store energy based on the input voltage applied from the rectifier circuit 110 while the switching circuit element is turned on. The output capacitor may be connected to the inductor through the first diode. Further, the output capacitor may provide an output voltage having a positive polarity by using energy stored in the inductor while the switching circuit element is turned off.

The protecting circuit 130 may be a circuit for protecting the PFC circuit 120. The protecting circuit may be referred to as, for example, a short-circuit protecting circuit, a short-circuit fault protecting circuit, etc.

Protection provided by the PFC circuit 120 may, based on an element of the PFC circuit 120 being short-circuited, protect malfunction in another element of the PFC circuit 120.

As aforementioned, the inductor and the output capacitor may be connected through the first diode. Therefore, based on the switching circuit element being turned on in a state where the first diode is short-circuited by a failure, the input voltage may be applied to the output capacitor. The input voltage has a negative polarity. Therefore, based on the input voltage being applied to the output capacitor, there may be a problem that a voltage having an opposite polarity is applied to the output capacitor, which may result in the output capacitor being damaged and exploding. According to the disclosure, the protecting circuit 130 may form a current path according to a voltage of both ends of the output capacitor based on the switching circuit element being turned on in a state where the first diode is short-circuited due to a failure. Accordingly, the protecting circuit 130 prevents a voltage having an opposite polarity from being applied to the output capacitor and thus the output capacitor may be protected.

Hereinafter, structures and operations of circuits are more specifically described.

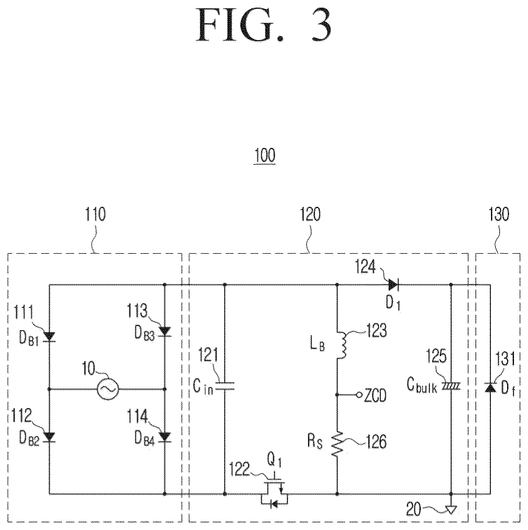

FIG. 3 is a view illustrating a rectifier circuit, a PFC circuit, and a protecting circuit according to an embodiment.

With reference to FIG. 3, the rectifier circuit 110 may include diode bridge include diodes 111, 112, 113, 114 connected in a bridge form. The diode bridge may be referred to as, for example, a bridge rectifier, etc.

An anode of a diode D_{B1} 111 may be connected to an anode of a diode D_{B3} 113 and a cathode of the diode D_{B1} 111 may be connected to an anode of a diode D_{B2} 112.

The anode of the diode D_{B2} 112 may be connected to the cathode of the diode D_{B1} 111 and a cathode of the diode D_{B2} 112 may be connected to a cathode of the diode D_{B4} 114.

The anode of the diode D_{B3} 113 may be connected to the anode of the diode D_{B1} 111 and a cathode of the diode D_{B3} 113 may be an anode of the diode D_{B4} 114.

The anode of the diode D_{B4} 114 may be connected to the cathode of the diode D_{B3} 113 and the cathode of the diode D_{B4} 114 may be connected to the cathode of the diode D_{B2} 112.

Also, the cathode of the diode D_{B1} 111 and the anode of the diode D_{B2} 112 may be connected to an AC voltage source 10 (e.g., one end (i.e., one terminal) of the AC voltage source 10) and the cathode of the diode D_{B3} 113 and the anode of the diode D_{B4} 114 may be connected to the AC voltage source 10 (e.g.: the other end (i.e., the other terminal) of the AC voltage source 10).

The PFC circuit 120 may include an input capacitor Cᵢₙ 121, a switching circuit element Q₁ 122, an inductor L_{B} 123, a first diode D₁ 124, an output capacitor C_{bulk} 125, and a resistor Rₛ 126.

The input capacitor Cᵢₙ 121 may receive an input voltage from the diodes 111, 112, 113, 114 of the diode bridge. For example, one end of the input capacitor Cᵢₙ 121 may be connected to the cathode of the diode D_{B2} 112 and the cathode of the diode D_{B4} 114 and the other end of the input capacitor Cᵢₙ 121 may be connected to the anode of the diode D_{B1} 111 and the anode of the diode D_{B3} 113.

Also, one end of the input capacitor Cᵢₙ 121 may be connected to a first end of a switching circuit element Q₁ 122. A first end of the switching circuit element Q₁ 122 may be a drain terminal. The other end of the input capacitor Cᵢₙ 121 may be connected to one end of the inductor L_{B} 123 and the anode of the first diode D₁ 124. The other end of the inductor L_{B} 123 may be connected to one end of the resistor R_{S} 126. The resistor R_{S} 126 may be a resistor for sensing current flowing through the inductor L_{B} 123.

Also, one end of the output capacitor C_{bulk} 125 may be connected to a cathode of the first diode D₁ 124 and the other end of the output capacitor C_{bulk} 125 may be connected to the other end of the resistor R_{S} 126, a second end of the switching circuit element Q₁ 122, and a ground voltage 20. The second end of the switching circuit element Q₁ 122 may be a source terminal of the switching element Q₁ 122.

The protecting circuit 130 may include a second diode D_{f} 131. The second diode D_{f} 131 may be connected to the output capacitor C_{bulk} 125 in parallel. For example, the cathode of the second diode D_{f} 131 may be connected to one end of the output capacitor C_{bulk} 125 and the anode of the second diode D_{f} 131 may be connected to the other end of the output capacitor C_{bulk} 125.

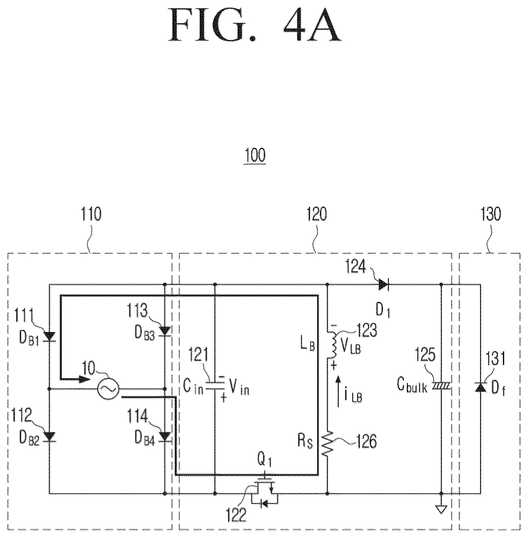

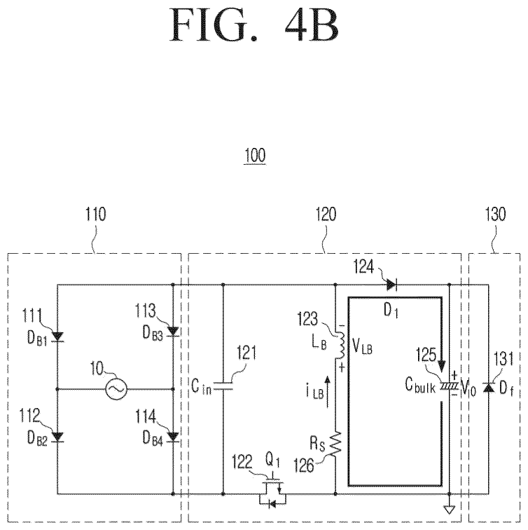

FIGS. 4A and 4B are views illustrating operations of a rectifier circuit, a PFC circuit, and a protecting circuit according to an embodiment.

The rectifier circuit 110 may rectify an AC voltage provided from the AC voltage source 10 by using the diodes 111, 112, 113, 114 of the diode bridge, and may apply an input voltage to the PFC circuit 120. For example, with reference to FIG. 4A, based on the switching circuit element Q₁ 122 being turned on, a negative input voltage—Vᵢₙ may be applied to the input capacitor Cᵢₙ 121 by the diodes 111, 112, 113, 114 of the diode bridge. A magnitude of a resistor value of the resistor Rₛ 126 is small and thus Vᵢₙ may be applied to the inductor L_{B} 123. Accordingly, a current i_{LB} of the inductor L_{B} 123 may increase and energy may be stored in the inductor L_{B} 123. The operation as the above may be referred to as a build-up operation.

With reference to FIG. 4B, based on the switching circuit element Q₁ 122 being turned off, a magnitude of a resistor value of the resistor Rₛ 126 is small and thus a negative output voltage (e.g., −Vₒ) may be applied to the inductor L_{B} 123. Accordingly, the current i_{LB} of the inductor L_{B} 123 may decrease, the output capacitor C_{bulk} 125 may be charged by energy stored in the inductor L_{B} 123 and power may be supplied to an output side. An operation as the above may be referred to as a powering operation.

As the above, the PFC circuit 120 may provide power to an output side according to turn-on/turn-off of the switching circuit element.

According to the disclosure, the PFC circuit 120 may be realized as a critical conduction mode (CrM) PFC circuit. That is, the PFC circuit 120 may be controlled in a CrM method. The CrM method may include a method of sensing current flowing through the inductor L_{B}, turning the switching circuit element on whenever current flowing through the inductor L_{B} arrive at zero, and driving the PFC circuit 120.

For example, the electronic device 100 may include a PFC controller and a gate driver. The PFC controller may include an integrated circuit (IC) chip. The controller may control a gate driver and apply a gate signal for turning the switching circuit element Q₁ 122, to a gate terminal of the switching circuit element Q₁ 122 which is in a state of turn-on.

Based on the switching circuit element Q₁ 122 being turned off, current flowing through the inductor L_{B} 123 may decrease. The PFC controller may sense current flowing through the inductor L_{B} 123 and may apply a gate signal for turning the switching circuit element Q₁ 122 on, to the gate terminal of the switching circuit element Q₁ 122 based on current flowing through the inductor L_{B} 123 arriving at zero. Further, the PFC controller may apply a gate signal for turning the switching circuit element Q₁ 122 off, to a gate terminal of the switching circuit element Q₁ 122 based on threshold time passing from a time point that the switching circuit element Q₁ 122 is turned on

The PFC controller may repetitively perform these operations and drive the PFC circuit in the CrM method.

The PFC circuit 120 shown in FIG. 3 may be driven in the CrM method based on of the inductor L_{B} 123 sensed by using the resistor Rₛ 126. That is, the PFC controller may sense current flowing through the inductor L_{B} 123 by using the resistor Rₛ 126 connected to the inductor L_{B} 123 in series and detect a time point where current flowing through the inductor L_{B} 123 is zero. Further, the PFC controller may turn the switching circuit element Q₁ 122 on based on current flowing through the inductor L_{B} 123 being zero. That is, the PFC controller may perform ZCD by using the resistor Rₛ 126. The ZCD may refer to detecting a time point where current flowing through the inductor of the converter is zero. Current passing through the node ZCD, which is connected between the inductor L_{B} 123 and the resistor Rₛ 126, may be monitored for ZCD.

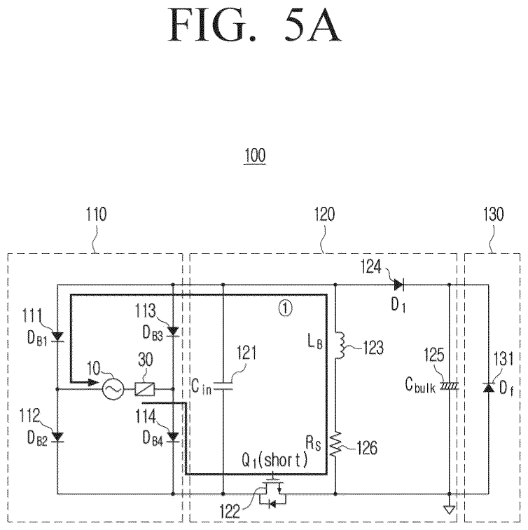

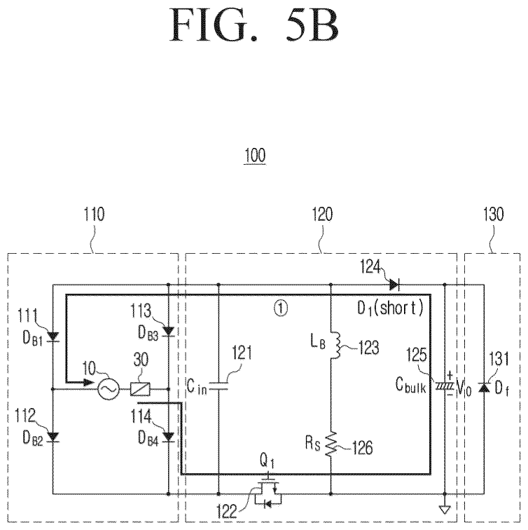

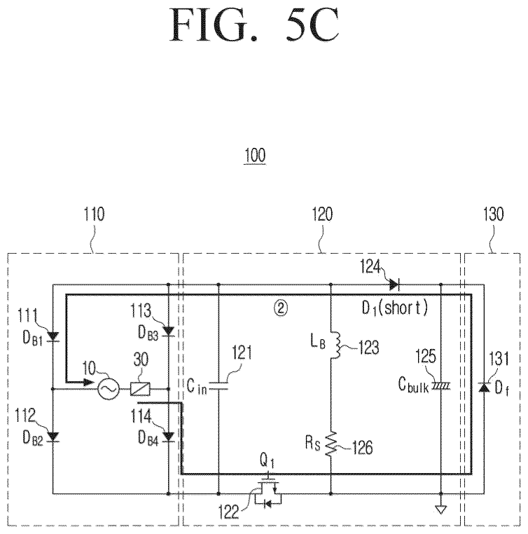

FIGS. 5A, 5B, and 5C are views illustrating operations for protecting the PFC circuit according to an embodiment.

As aforementioned, the PFC circuit 120 may operate as a step-down converter. In this case, there may be a problem that the output capacitor C_{bulk} 125 explodes based on an active element (e.g., the switching circuit element Q₁ 122, the first diode D₁ 124) of the PFC circuit 120 being short-circuited by a failure. According to the disclosure, based on the active element (specifically, the first diode D₁ 124) being short-circuited, the output capacitor C_{bulk} 125 may be protected by using the protecting circuit 130.

With reference to FIGS. 5A and 5B, the electronic device 100 may include a fuse 30. One end of the fuse 30 may be connected to the other end of the AC voltage source 10 (e.g., the other end of the AC voltage source 10) and the other end of the fuse 30 may be connected to the cathode of the diode D_{B3} 113 and the anode of the diode D_{B4} 114. The embodiments are not limited thereto and the fuse 30 may be connected to various positions. For example, one end of the fuse 30 may be connected to the AC voltage source 10 (e.g., one end of the AC voltage source 10) and the other end of the fuse 30 may be connected to the cathode of the diode D_{B1} 111 and the anode of the diode D_{B2} 112. As the above, the fuse 30 may be disposed in various positions on a current path where current output from the AC voltage source 10 flow or a current path where current input to the AC voltage source 10 flow.

FIG. 5A is a view illustrating a case that the switching circuit element Q₁ 122 is short-circuited due to a failure.

Based on the switching circuit element Q₁ 122 being short-circuited due to a failure, the fuse 30 opens due to current of the switching circuit element Q₁ 122, and the operation of the PFC circuit 120 may be terminated.

With reference to FIG. 5A, based on the switching circuit element Q₁ 122 being short-circuited due to a failure, current of the output capacitor C_{bulk} 125 are blocked by the first diode D₁ 124. Therefore, current flowing through the inductor L_{B} 123 (\textcircled{1} of FIG. 5A) may increase due to a voltage of an input side and the fuse 30 may be disconnected as current increase. Accordingly, the operation of the PFC circuit 120 may be stably terminated and elements of the PFC circuit 120 may be protected.

FIGS. 5B and 5C are views illustrating cases that the first diode D₁ 124 is short-circuited due to a failure.

With reference to FIG. 5B, based on the switching circuit element Q₁ 122 being turned on in a state where the first diode D₁ 124 is short-circuited due to a failure, a voltage charged in the output capacitor C_{bulk} 125 may be discharged by the input voltage. That is, current may flow to the first diode D₁ 124 and the output capacitor C_{bulk} 125, by the input voltage (\textcircled{1} of FIG. 5B) and electric charges charged in the output capacitor C_{bulk} 125 may be discharged by current.

Accordingly, a voltage (Vₒ) of both ends of the output capacitor C_{bulk} 125 may be lowered.

With reference to FIG. 5C, based on a voltage of both ends of the output capacitor C_{bulk} 125 becoming zero (or a threshold voltage of the first diode D₁ 124), a current path may be formed by the second diode D_{f} 131 and current may flow through the current path (\textcircled{2} of FIG. 5C). Current flowing through the current path may increase and thus the fuse 30 may be disconnected as current increase. Accordingly, the operation of PFC circuit 120 may be stably terminated and elements of the PFC circuit 120 may be protected.

As the above, according to the disclosure, based on the active element (specifically, the first diode D₁ 124) being short-circuited due to a failure, it is prevented that a negative voltage is applied to the output capacitor C_{bulk} 125 thanks to the second diode D_{f} 131 and thus explosion of the output capacitor C_{bulk} 125 may prevented.

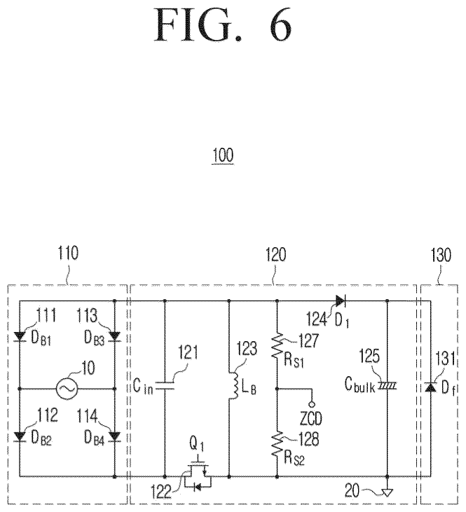

FIG. 6 is a view illustrating a rectifier circuit, a PFC circuit, and a protecting circuit according to an embodiment.

With reference to FIG. 6, the rectifier circuit 110 may include a diode bridge including diodes 111, 112, 113, 114 connected in a bridge form.

The anode of the diode D_{B1} 111 may be connected to the anode of the diode D_{B3} 113 and the cathode of the diode D_{B1} 111 may be connected to the anode of the diode D_{B2} 112.

The anode of the diode D_{B2} 112 may be connected to the cathode of the diode D_{B1} 111 and the cathode of the diode D_{B2} 112 may be connected to the cathode of the diode D_{B4} 114.

The anode of the diode D_{B3} 113 may be connected to the anode of the diode D_{B1} 111 and the cathode of the diode D_{B3} 113 may be connected to the anode of the diode D_{B4} 114.

The anode of the diode D_{B4} 114 may be connected to the cathode of the diode D_{B3} 113 and the cathode of the diode D_{B4} 114 may be connected to the cathode of the diode D_{B2} 112.

Also, the cathode of the diode D_{B1} 111 and the anode of the diode D_{B2} 112 may be connected to the AC voltage source 10 (e.g., one end of the AC voltage source 10) and the cathode of the diode D_{B3} 113 and the anode of the diode D_{B4} 114 may be connected to the AC voltage source 10 (e.g., the other end of the AC voltage source 10).

The PFC circuit 120 may include the input capacitor Cᵢₙ 121, the switching circuit element Q₁ 122, the inductor L_{B} 123, the first diode D₁ 124, the output capacitor C_{bulk} 125, a first resistor Rₛ₁ 127, and a second resistor Rₛ₂ 128.

The input capacitor Cᵢₙ 121 may receive an input voltage from the diodes 111, 112, 113, 114 of the diode bridge. For example, one end of the input capacitor Cᵢₙ 121 may be connected to the cathode of the diode D_{B2} 112 and the cathode of the diode D_{B4} 114 and the other end of the input capacitor Cᵢₙ 121 may be connected to the anode of the diode D_{B1} 111 and the anode of the diode D_{B3} 113.

Also, one end of the input capacitor Cᵢₙ 121 may be connected to a first end of the switching circuit element Q₁ 122. The first end of the switching circuit element Q₁ 122 may be a drain terminal. The other end of the input capacitor Cᵢₙ 121 may be connected to one end of the inductor L_{B} 123, the anode of the first diode D₁ 124, and one end of the first resistor Rₛ₁ 127.

The first resistor Rₛ₁ 127 and the second resistor Rₛ₂ 128 may be connected in series. For example, the other end of the first resistor Rₛ₁ 127 may be connected to one end of the second resistor Rₛ₂ 128.

Also, one end of the output capacitor C_{bulk} 125 may be connected to the cathode of the first diode D₁ 124 and the other end of the output capacitor C_{bulk} 125 may be connected to the other end of the inductor L_{B} 123, the other end of the second resistor Rₛ₂ 128, a second end of the switching circuit element Q₁ 122, and a ground voltage 20. The second end of the switching circuit element Q₁ 122 may be a source terminal of the switching circuit element Q₁ 122.

The protecting circuit 130 may include the second diode D_{f} 131. The second diode D_{f} 131 may be connected to the output capacitor C_{bulk} 125 in parallel. For example, the cathode of the second diode D_{f} 131 may be connected to one end of the output capacitor C_{bulk} 125 and the anode of the second diode D_{f} 131 may be connected to the other end of the output capacitor C_{bulk} 125.

With reference to FIGS. 3 and 6, connection structures of other elements except connection structures of resistors are substantially similar. Therefore, the contents described in FIGS. 4A, 4B, 5A, 5B, and 5C may be applied to a circuit shown in FIG. 6.

With reference to FIG. 3, the resistor Rₛ 126 may be used for ZCD. The resistor Rₛ 126 may be connected to the inductor L_{B} 123 in series with the node ZCD connected therebetween. With reference to FIG. 6, the first resistor Rₛ₁ 127 and the second resistor Rₛ₂ 128 connected in series may be used for ZCD. In this regard, the node ZCD may be connected in series between the first resistor Rₛ₁ 127 and the second resistor Rₛ₂ 128. The first resistor Rₛ₁ 127 and the second resistor Rₛ₂ 128 connected in series may be connected to the inductor L_{B} 123 in parallel.

The PFC circuit 120 shown in FIG. 6 may be driven in the CrM method based on current of the inductor L_{B} 123 sensed by using the first resistor Rₛ₁ 127 and the second resistor Rₛ₂ 128. That is, the PFC controller may sense a voltage of both ends of the inductor L_{B} 123 by using the first resistor Rₛ₁ 127 and the second resistor Rₛ₂ 128 connected to the inductor L_{B} 123 in parallel to sense current flowing through the inductor L_{B} 123, and detect a time point where current flowing through the inductor L_{B} 123 is zero. Further, the PFC controller may turn the switching circuit element Q₁ 122 on based on current flowing through the inductor L_{B} 123 becoming zero. That is, the PFC controller may perform ZCD by using the first resistor Rₛ₁ 127 and the second resistor Rₛ₂ 128.

As the above, the ZCD operation may be performed by sensing current or voltages of the inductor by using resistors without an additional winding of the inductor for the ZCD operation. Accordingly, an ultra-slim power supply may be provided by using the PFC circuit 120.

FIGS. 4A, 5A, 5B, and 5C illustrate that a voltage of one polarity of the AC voltage source (e.g., a voltage having a (+) polarity) is input to the rectifier circuit 110 but embodiments are not limited thereto. That is, even though a voltage having another polarity of the AC voltage source (e.g., a voltage having a (−) polarity) is input to the rectifier circuit 110, the aforementioned contents may be similarly applied.

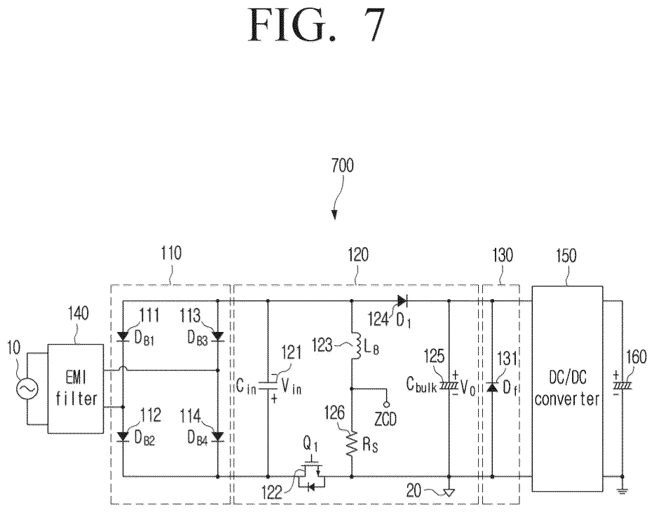

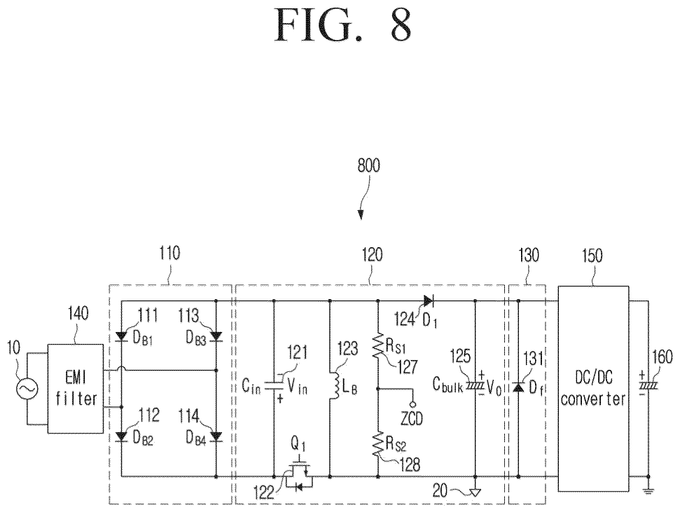

FIGS. 7 and 8 are views of an example of power circuits according to embodiments.

The electronic device 100 may include a power circuit 700 shown in FIG. 7 or a power circuit 800 shown in FIG. 8.

The power circuit 700 shown in FIG. 7 may include the rectifier circuit 110, the PFC circuit 120, and the protecting circuit 130 described in FIG. 3. The contents described to structures and operations of theses circuits may be applied to the power circuit 700 shown in FIG. 7.

The power circuit 800 shown in FIG. 8 may include the rectifier circuit 110, the PFC circuit 120, and the protecting circuit 130 described in FIG. 6. The contents described to structures and operations of theses circuits may be applied to the power circuit 800 shown in FIG. 8.

With respect to FIGS. 7 and 8, an electromagnetic interference (EMI) filter 140 may receive an AC voltage from the AC voltage source 10. Further, the EMI filter 140 may remove a noise from the AC voltage. The EMI filter 140 may include various elements such as a capacitor, an inductor, and a reactor. For example, the EMI filter 140 may discharge power to a spike through a resistor, discharge a noise through a capacitor, or remove a noise through an inductor. Embodiments are not limited thereto and the EMI filter 140 may remove a noise by using various methods.

Further, the EMI filter 140 may apply the AC voltage where a noise is removed (i.e., a filtered AC voltage) to the rectifier circuit 110. The rectifier circuit 110 may receive the AC voltage in which a noise is removed by the EMI filter 140 and apply a negative input voltage (e.g., −Vᵢₙ) to the PFC circuit 120 by rectifying the AC voltage.

A DC/DC converter 150 may output a direct current (DC) voltage having a voltage range in which an operation of various configurations of the electronic device 100 are possible. For example, the output voltage (e.g., Vₒ) of the PFC circuit 120 may be applied to the DC/DC converter 150. The DC/DC converter 150 may convert an input voltage to a voltage suitable for configurations of the electronic device 100 and may output the voltages. An output voltage of the DC/DC converter 150 may be applied to an output capacitor 160.

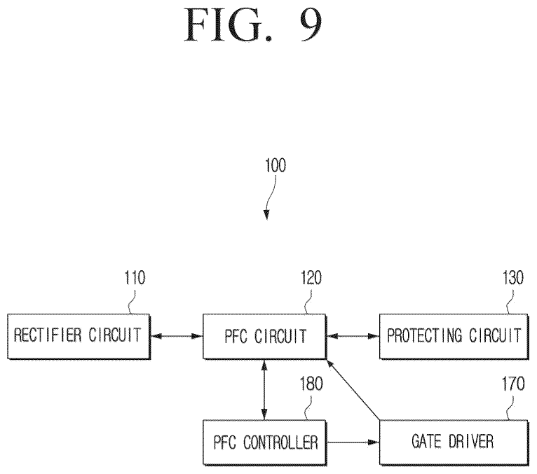

FIG. 9 is a block diagram illustrating a configuration of the electronic device according to an embodiment.

With reference to FIG. 9, the electronic device 100 may include the rectifier circuit 110, the PFC circuit 120, the protecting circuit 130, a gate driver (i.e., a gate driver circuit) 170, and a PFC controller (i.e., a PFC control circuit) 180. Among configurations shown in FIG. 9, the aforementioned contents may be applied to the rectifier circuit 110, the PFC circuit 120, and the protecting circuit 130. Therefore, the repetitive description thereof is omitted for conciseness.

The gate driver 170 may generate a gate signal for controlling a switching operation of the switching circuit element Q₁ 122 of the PFC circuit 120 and apply the gate signal to a gate terminal of the switching circuit element Q₁ 122.

The PFC controller 180 may control a gate driver 170 to drive the PFC circuit 120 in a CrM method.

For example, the PFC controller 180 may apply a gate signal for turning the switching circuit element Q₁ 122 on to a gate terminal of the switching circuit element Q₁ 122 by controlling the gate driver 170. The switching circuit element Q₁ 122 may be turned on based on the gate signal being applied from the gate driver 170.

Further, the PFC controller 180, based on a threshold time passing from a time point that the switching circuit element Q₁ 122 is turned on, may apply a gate signal for turning the switching circuit element Q₁ 122 off, to a gate terminal of the switching circuit element Q₁ 122 by controlling the gate driver 170. The switching circuit element Q₁ 122 may be turned off based on the gate signal being applied from the gate driver 170.

Based on the switching circuit element Q₁ 122 being turned off, current flowing through the inductor L_{B} 123 may be reduced. The PFC controller 180 may sense current flowing through the inductor L_{B} 123 by using the resistor 126 connected to the inductor L_{B} 123 in series or sense current flowing through the inductor L_{B} 123 by using the resistors 126, 127 connected to the inductor L_{B} 123 in parallel, thereby sensing whether current flowing through the inductor L_{B} 123 arrive at zero.

Further, the PFC controller 180 may apply a gate signal for turning the switching circuit element Q₁ 122 on, to a gate terminal of the switching circuit element Q₁ 122 by controlling the gate driver 170 based on current flowing through the inductor L_{B} 123 being zero.

Thereafter, the PFC controller 180, based on a threshold time passing from a time point that the switching circuit element Q₁ 122 is turned on, may apply a gate signal for turning the switching circuit element Q₁ 122 off, to a gate terminal of the switching circuit element Q₁ 122 by controlling the gate driver 170. Further, the PFC controller 180 may sense current flowing through the inductor L_{B} 123 and based on current flowing through the inductor L_{B} 123 being zero, may apply a gate signal for turning the switching circuit element Q₁ 122 on, to a gate terminal of the switching circuit element 122.

The PFC controller 180 may drive the PFC circuit in the CrM method by repetitively performing these operations.

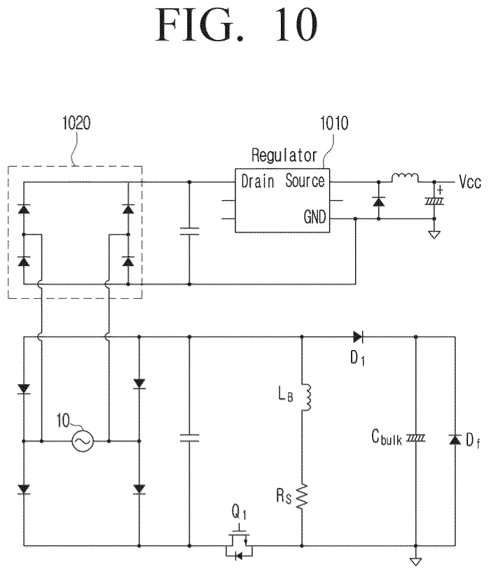

FIG. 10 is a view illustrating a method of providing power to the PFC controller according to an embodiment.

With reference to FIG. 10, according to the disclosure, a power voltage Vcc for the PFC controller 180 may be generated through a regulator 1010 by connecting the regulator 1010 to the AC voltage source 10 through a rectifying circuit 1020.

FIG. 10 illustrates a buck regulator but embodiments are not limited thereto. The regulator may be realized as, for example, a linear regulator, etc.

Also, FIG. 10 illustrates a circuit shown in FIG. 3 as an example but embodiments are not limited thereto. As shown in FIG. 10, a circuit of generating power for the PFC controller 180 may be configured by connecting a rectifier circuit, a capacitor, a regulator, a diode, an inductor, etc., to the circuit shown in FIG. 6.

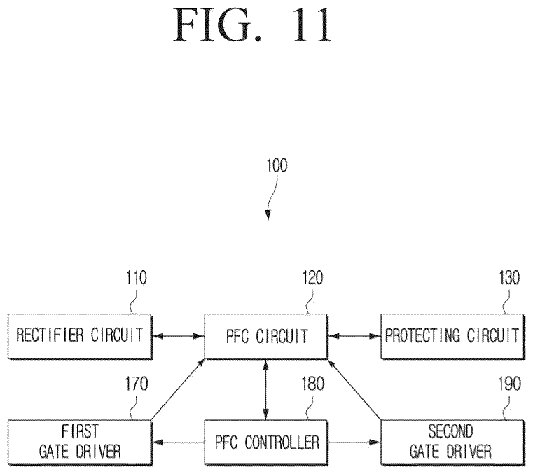

According to an embodiment, the first diode D₁ 124 may be substituted with a synchronous rectifier (SR). In this case, the electronic device 100 may further include a gate driver for controlling a switching operation of the synchronous rectifier. An example in which the first diode D₁ 124 is substituted with the synchronous rectifier is more specifically described in FIG. 11.

FIG. 11 is a block diagram illustrating a configuration of an electronic device according to an embodiment.

With reference to FIG. 11, an electronic device 100 may include a rectifier circuit 110, a PFC circuit 120, a protecting circuit 130, a first gate driver (i.e., first gate driver circuit) 170, a PFC controller (i.e., a PFC control circuit) 180, and a second gate driver (i.e., second gate driver circuit) 190.

In FIG. 11, the first diode D₁ 124 of the PFC circuit 120 shown in FIG. 10 may be substituted with a synchronous rectifier. The synchronous rectifier may be realized with a switching circuit element such as, for example, MOSFET.

For example, in the PFC circuit 120 shown in FIG. 3, a source terminal of the synchronous rectifier may be connected to the other end of the input capacitor Cᵢₙ 121 and one end of the inductor L_{B} 123. A drain terminal of the synchronous rectifier may be connected to one end of the output capacitor C_{bulk} 125 and a cathode of the second diode D_{f} 131.

For example, in the PFC circuit 120 shown in FIG. 6, a source terminal of the synchronous rectifier may be connected to the other end of the input capacitor Cᵢₙ 121, one end of the inductor L_{B} 123 and one end of the first resistor (Rₛ₁) 127. A drain terminal of the synchronous rectifier may be connected to one end of the output capacitor C_{bulk} 125 and a cathode of the second diode D_{f} 131.

In FIG. 11, a gate driver 170 for controlling a switching circuit element Q₁ 122 is described as the first gate driver 170 and a gate driver for controlling the synchronous rectifier is described as a second gate driver 190. The aforementioned contents may be applied to the rectifier circuit 110, the PFC circuit 120, the protecting circuit 130, the PFC controller 180, and the first gate driver 170 among configurations shown in FIG. 11. Therefore, the repetitive description thereof is omitted for conciseness.

The second gate driver 190 may generate a gate signal for controlling a switching operation of the synchronous rectifier and apply a gate signal to a gate terminal of the synchronous rectifier.

The PFC controller 180 may control the second gate driver 190. For example, the PFC controller 180 may apply a gate signal for turning the synchronous rectifier off to a gate terminal of the synchronous rectifier at a time point in which the switching circuit element Q₁ 122 is turned on by controlling the second gate driver 190. Also, the PFC controller 180 may apply a gate signal for turning the synchronous rectifier on to the gate terminal of the synchronous rectifier at a time point in which the switching circuit element Q₁ 122 is turned off by controlling the second gate driver 190.

Therefore, the synchronous rectifier is turned off while the switching circuit element Q₁ 122 is turned on, and the synchronous rectifier is turned on while the switching circuit element Q₁ 122 is turned off. Accordingly, the synchronous rectifier may perform the same function as that of the diode 124.

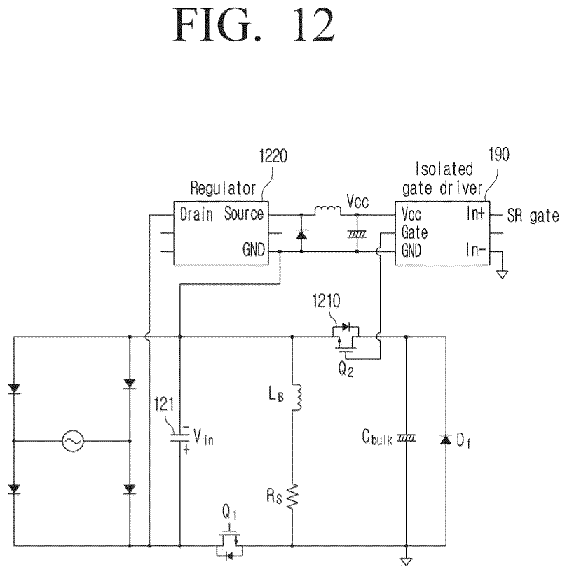

FIG. 12 is a view illustrating a method of providing power to the second gate driver according to an embodiment.

With reference to FIG. 12, if the diode 124 is substituted with the synchronous rectifier, a source terminal of a synchronous rectifier Q2 1210 is separated from a ground and floats. In this regard, the second gate driver 190 may be realized as an isolated gate driver. In this regard, as shown in FIG. 12, a circuit for providing power to the second gate driver 190 may be provided.

With reference to FIG. 12, because the other end (e.g., a (−) polarity of an input voltage Vᵢₙ) of the input capacitor 121 and a source terminal of the synchronous rectifier Q₂ 1210 are the same nodes, a power voltage Vcc generated by the regulator 1220 which receives the input voltage may be used as power for driving the second gate driver 190.

FIG. 12 illustrates a buck regulator but embodiments are not limited thereto. The regulator may be realized as, for example, a linear regulator, etc.

Also, in FIG. 12, the circuit shown in FIG. 3 is illustrated as an example but embodiments are not limited thereto. A circuit of generating power for the second gate driver 190 may be configured by connecting a regulator, a diode, an inductor, a capacitor, etc., to the circuit shown in FIG. 6, as shown in FIG. 12.

According to an embodiment, a connection structure of the switching circuit element Q₁ 122 and the first diode D₁ 124 may be variously changed in the PFC circuit 120.

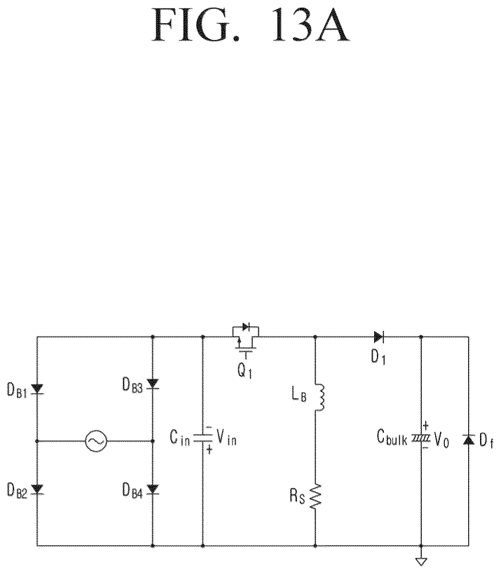

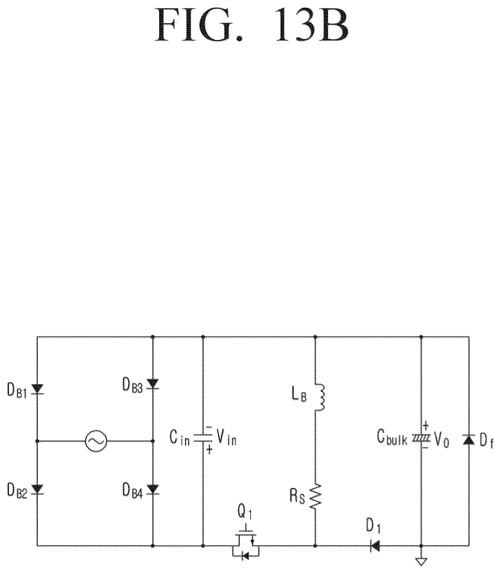

For example, the connection structure of the switching circuit element Q₁ 122 and the first diode D₁ 124 in the PFC circuit 120 shown in FIG. 3 may be changed to that as shown in FIGS. 13A and 13B.

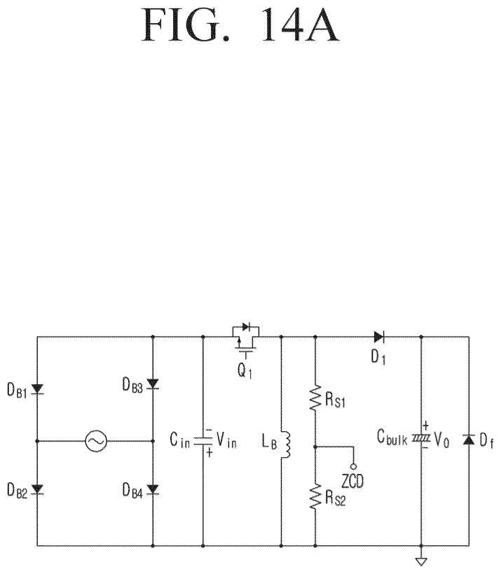

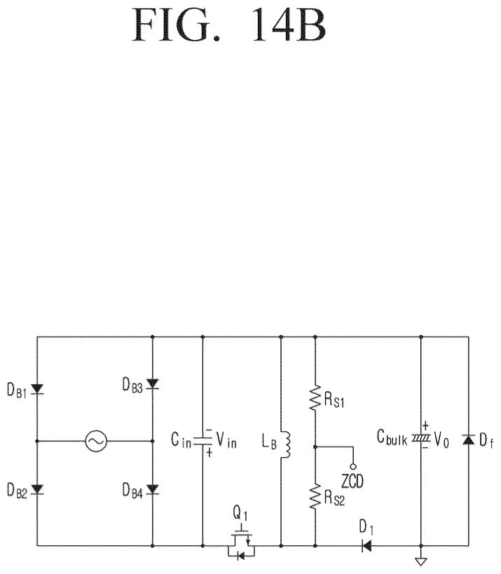

Also, the connection structure of the switching circuit element Q₁ 122 and the first diode D₁ 124 in the PFC circuit 120 shown in FIG. 6 may be changed to that as shown in FIGS. 14A and 14B.

Referring to FIGS. 13a, 13b, 14a, and 14b, the switching element Q₁ 122 and the first diode L_{B} 124 may be arranged on the same line, and accordingly, the EMI characteristics can be improved.

Circuits shown in FIGS. 13A, 13B, 14A, and 14B operate substantially similar to circuits shown in FIGS. 3 and 6. In this regard, the aforementioned contents may be applied to the circuits shown in FIGS. 13A, 13B, 14A, and 14B. Also, in the circuits shown in FIGS. 13A, 13B, 14A, and 14B, the first diode D₁ 124 may be substituted with the synchronous rectifier. Also, a power circuit may be configured by connecting the EMI filter 140, the DC/DC converter 150, and the output capacitor 160 to the circuits shown in FIGS. 13A, 13B, 14A, and 14B.

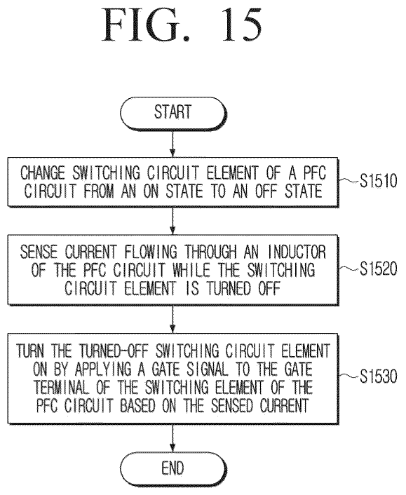

FIG. 15 is a flow chart illustrating a method of controlling a PFC circuit of an electronic device according to an embodiment.

The electronic device includes a PFC circuit, a rectifier circuit configured to rectify an AC voltage and applying an input voltage having a negative polarity to a PFC circuit, and a protecting circuit for protecting the PFC circuit.

In operation S1510, a switching circuit element is changed from an on state to an off state by applying a gate signal to a gate terminal of a switching circuit element of the PFC circuit.

In operation S1520, current flowing through the inductor of the PFC circuit are sensed while the switching circuit element is turned off.

In operation S1530, the turned-off switching circuit element is turned on by applying a gate signal to a gate terminal of the switching circuit element of the PFC circuit based on the sensed current.

The PFC circuit includes an inductor in which energy is stored based on the input voltage applied from the rectifier circuit while the switching circuit element is turned on, and an output capacitor which is connected to the inductor through the first diode and provides an output voltage having a positive polarity by using the stored energy while the switching circuit element is turned off. Further, based on the first diode being short-circuited, the PFC circuit is protected by the current path formed by the protecting circuit while the switching circuit element is turned on.

Also, the protecting circuit may include a second diode connected to the output capacitor in parallel.

Also, the rectifier circuit may include a diode bridge. The PFC circuit further include an input capacitor which receives the input voltage from the diode bridge.

For example, the first end of the switching circuit element may be connected to one end of the input capacitor. One end of the inductor may be connected to the other end of the input capacitor and an anode of the first diode. The other end of the inductor may be connected to one end of a resistor. Also, one end of the output capacitor may be connected to a cathode of the first diode and a cathode of the second diode and the other end of the output capacitor may be connected to the other end of the resistor, the second end of the switching circuit element, a ground voltage, and an anode of the second diode.

In this case, the resistor may be a resistor for sensing current flowing through the inductor. In the operation S1520, current of the inductor may be sensed by using the resistor.

For example, the first end of the switching circuit element may be connected to one end of the input capacitor. One end of the inductor may be connected to the other end of the input capacitor, the anode of the first diode, and one end of the first resistor. The other end of the first resistor may be connected to one end of the second resistor. Also, one end of the output capacitor may be connected to the cathode of the first diode and the cathode of the second diode. The other end of the output capacitor may be connected to the other end of the inductor, the other end of the second resistor, the second end of the switching circuit element, a ground voltage, and the anode of the second diode.

In this case, the first and second resistors may be used for sensing current flowing through the inductor. In the operation S1520, current of the inductor may be sensed by using the first and second resistors.

Also, based on the switching circuit element being turned on in a state where the first diode is short-circuited due to a failure, a voltage charged by the input voltage in the output capacitor is discharged. Based on a voltage of both ends of the output capacitor becoming zero according to the discharge, a current path may be formed by the second diode.

Also, the rectifier circuit may further include a fuse. In this case, an operation of the PFC circuit may be terminated by disconnection of the fuse due to current flowing through the current path.

Various examples of the disclosure may be realized within a recording medium which may be read by a computer or a device similar with the same by using hardware, or combinations thereof. In some cases, embodiments described in the disclosure may be realized by a processor itself.

According to various embodiments of the disclosure as the above, computer instructions to perform a processing operation of the electronic device may be stored in a non-transitory computer-readable medium.

The non-transitory computer-readable medium does not refer to a medium which may store data for a short period such as a register, a cache, and memory but refers to a medium which may semipermanently store data and be read by the machine. Specific examples of the non-transitory computer-readable medium may be a compact disc (CD), a digital video/versatile disc (DVD, a hard disk, a blue-ray disk, a Universal Serial Bus (USB) storage device, a memory card, a read-only memory (ROM), etc.

While aspects of embodiments have been particularly shown and described, it will be understood that various changes in form and details may be made therein without departing from the spirit and scope of the following claims.

What is claimed is:

1. An electronic device, comprising:
a power factor correction (PFC) circuit;
a rectifier circuit configured to rectify an alternating current voltage to obtain an input voltage having a negative polarity and provide the input voltage to the PFC circuit; and
a protecting circuit configured to protect the PFC circuit,
wherein the PFC circuit comprises:
a first diode;
an inductor configured to store energy based on the input voltage provided by the rectifier circuit while a switching circuit is turned on and provide energy while the switching circuit is turned off; and
an output capacitor connected to the inductor through the first diode, and configured to provide an output voltage having a positive polarity by using the energy provided by the inductor while the switching circuit is turned off, and
wherein based on the first diode being short-circuited, the PFC circuit is protected by a current path formed by the protecting circuit while the switching circuit is turned on.

2. The electronic device of claim 1, wherein the protecting circuit comprises a second diode which is connected to the output capacitor in parallel.

3. The electronic device of claim 2, wherein the rectifier circuit comprises a diode bridge, and
wherein the PFC circuit further comprises an input capacitor configured to receive the input voltage from the diode bridge.

4. The electronic device of claim 3, wherein a first end of the switching circuit is connected to one end of the input capacitor,
wherein one end of the inductor is connected to another end of the input capacitor and an anode of the first diode,
wherein another end of the inductor is connected to one end of a resistor,
wherein one end of the output capacitor is connected to a cathode of the first diode and a cathode of the second diode,
wherein another end of the output capacitor is connected to the other end of the resistor, a second end of the switching circuit, a ground voltage, and an anode of the second diode, and
wherein the resistor is used to sense current flowing through the inductor.

5. The electronic device of claim 4, wherein the PFC circuit is driven in a critical conduction mode (CrM) based on the current flowing through the inductor, and
wherein the current is sensed using the resistor.

6. The electronic device of claim 3, wherein a first end of the switching circuit is connected to one end of the input capacitor,
wherein one end of the inductor is connected to another end of the input capacitor, an anode of the first diode, and one end of a first resistor,
wherein another end of the first resistor is connected to one end of a second resistor,
wherein one end of the output capacitor is connected to a cathode of the first diode and a cathode of the second diode,
wherein another end of the output capacitor is connected to another end of the inductor, another end of the second resistor, a second end of the switching circuit, a ground voltage, and an anode of the second diode, and
wherein the first resistor and the second resistor are used to sense current flowing through the inductor.

7. The electronic device of claim 6, wherein the PFC circuit is driven in a CrM based on the current of the inductor sensed using the first resistor and the second resistor.

8. The electronic device of claim 2, wherein based on the switching circuit being turned on in a state where the first diode is short-circuited due to a failure, a voltage charged in the output capacitor by the input voltage is discharged, and
wherein based on the voltage of both ends of the output capacitor becoming zero according to the discharge, the current path flows through the second diode.

9. The electronic device of claim 8, further comprising a fuse,
wherein the fuse is disconnected by current flowing through the current path to terminate an operation of the PFC circuit.

10. The electronic device of claim 2, further comprising a fuse,
wherein based on the switching circuit being short-circuited due to a failure, the fuse is disconnected by current flowing through the switching circuit to terminate and an operation of the PFC circuit.

11. The electronic device of claim 1, further comprising:
an electromagnetic interference (EMI) filter configured to filter a source alternating current voltage and provide the alternating current voltage to the rectifier circuit, and
a DC/DC converter to which the output voltage is applied.

12. A method for controlling a power factor correction (PFC) circuit of an electronic device, including a PFC circuit, a rectifier circuit configured to apply an input voltage having a negative polarity to the PFC circuit by rectifying an alternating current voltage, and a protecting circuit configured to protect the PFC circuit, the method comprising:
controlling a switching circuit from an on state to an off state by applying a gate signal to a gate terminal of the switching circuit of the PFC circuit;
sensing current flowing through an inductor of the PFC circuit while the switching circuit is in the off state;
controlling the switching circuit from the off state to the on state by applying the gate signal to the gate terminal of the switching circuit of the PFC circuit based on the sensed current;
storing energy in the inductor based on the input voltage applied from the rectifier circuit while the switching circuit is in the on state; and
providing, while the switching circuit is in the off state, an output voltage having a positive polarity using an output capacitor of the PFC circuit that is connected to the inductor through a first diode,
wherein based on the first diode being short-circuited, the PFC circuit is protected by a current path formed by the protecting circuit while the switching circuit is turned on.

13. The method of claim 12, wherein the protecting circuit includes a second diode which is connected to the output capacitor in parallel.

14. The method of claim 13, wherein the rectifier circuit comprises a diode bridge, and
wherein the method further comprises receiving the input voltage from the rectifier circuit at an input capacitor of the PFC circuit.

15. The method of claim 14, wherein one end of the switching circuit is connected to one end of the input capacitor,
wherein one end of the inductor is connected to another end of the input capacitor and an anode of the first diode,
wherein another end of the inductor is connected to one end of a resistor, wherein one end of the output capacitor is connected to a cathode of the first diode and a cathode of the second diode,
wherein another end of the output capacitor is connected to another end of the resistor, a second end of the switching circuit, a ground voltage, and an anode of the second diode, and
wherein the method further comprises sensing current flowing through the inductor using the resistor.

16. The method of claim 15, wherein the PFC circuit is driven in a critical conduction mode (CrM) based on the current flowing through the inductor, and
wherein the current is sensed using the resistor.

17. The method of claim 14, wherein a first end of the switching circuit is connected to one end of the input capacitor;
wherein one end of the inductor is connected to another end of the input capacitor, an anode of the first diode, and one end of a first resistor,
wherein another end of the first resistor is connected to one end of a second resistor, wherein one end of the output capacitor is connected to a cathode of the first diode and a cathode of the second diode,
wherein another end of the output capacitor is connected to another end of the inductor, another end of the second resistor, a second end of the switching circuit, a ground voltage, and an anode of the second diode, and
wherein the first resistor and the second resistor are used to sense current flowing through the inductor.

18. An electronic device, comprising:
a power factor correction (PFC) circuit;
a protecting circuit comprising:
a first diode;
an inductor configured to store energy based on an input voltage while a switching circuit is turned on and provide energy while the switching circuit is turned off; and
an output capacitor connected to the inductor through the first diode, and configured to provide an output voltage having a positive polarity by using the energy provided by the inductor while the switching circuit is turned off; and
a PFC controller configured to control the switching circuit to turn on and off based on current flowing through the inductor.

19. The electronic device of claim 18, wherein the PPC controller is further configured to control the switching circuit to turn on based on the current flowing through the inductor being zero.

20. The electronic device of claim 19, wherein the PPC controller is further configured to control the switching circuit to turn off based on a threshold time passing after controlling the switching circuit to turn on.
